(19) United States
(12) Patent Application Publication
(10) Pub. No.: US 2013/0280087 A1
(43) Pub. Date: Oct. 24, 2013

(54) COMPOSITE STRUCTURES

(71) Applicants: Steve Appleton, Fleet (GB); Mark Forrest, London (GB)

(72) Inventors: Steve Appleton, Fleet (GB); Mark Forrest, London (GB)

(73) Assignee: VESTAS WIND SYSTEMS A/S, Aarhus N (DK)

(21) Appl. No.: 13/881,934

(22) PCT Filed: Oct. 26, 2011
(86) PCT No.: PCT/GB2011/052076

§ 371 Date: Jul. 10, 2013

(30) Foreign Application Priority Data
Oct. 26, 2010 (GB) 1018082.6

(51) Int. Cl. H01Q 17/00; F03D 11/00

(52) U.S. Cl. CPC H01Q 17/00; F03D 11/00
USPC 416/241 A; 428/316.6; 428/172; 428/201; 428/136

(57) ABSTRACT

A foam core for a composite structure is described. The core includes a first core layer (62) and a second core layer (64). The first core layer (62) is a dielectric foam material and the second core layer (64) is a radar reflecting ground plane comprising an electrically conductive foam material.

### FIELD OF THE INVENTION

The present invention relates to radar absorbing materials (RAM) used in the construction of composite structures such as wind turbine blades. In particular, the present invention relates to sandwich panel cores incorporating RAM, and to composite structures incorporating such cores.

### BACKGROUND

It is desirable to introduce radar absorbing material (RAM) into composite structures such as wind turbine components, for example wind turbine blades. One reason for this is that rotating blades have a radar signature similar to that of aircraft, which can make it difficult for air traffic control and other radar operators to distinguish between aircraft and wind turbines. Incorporating RAM into such structures ensures that the resulting structure has a reduced radar signature that can be distinguished easily from aircraft, and which creates less unwanted events (also known as ‘clutter’) on the screen of the radar operator.

Existing wind turbine blades are generally manufactured from reinforced composite materials. A typical blade is fabricated in two shells, which are subsequently united to form a single hollow unit. The shells include at particular locations sandwich panel regions having a core of lightweight material such as foam or balsa wood.

By way of background, FIG. 1 shows a cross section of a wind turbine blade 10. The blade 10 is constructed from two aerodynamic shells, upper shell 11 and lower shell 12 which are formed from a glass fibre cloth and resin composite. The shells 11 and 12 are supported by a tubular structural spar 13 formed from glass fibre and carbon fibre.

The spar 13 forms the primary strengthening structure of the blade 10. At the rear of each shell 11 and 12 towards the trailing edge of the blade 10, the shells are formed with a sandwich panel construction, in which a foam core 14 is positioned between sheets or ‘skins’ of glass fibre 15 and 16. The foam core 14 is used to separate the glass fibre skins 15 and 16 to keep the shell stiff in this region.

FIG. 2 shows an exploded sectional perspective view of part of a sandwich panel region of the blade 10. The sandwich panel comprises the foam core 14, which has an inner surface 17 and an outer surface 18. The core 14 is disposed between the inner skin 16 and the outer skin 15. The outer surface 18 of the core 14 and the outer skin 15 face towards an exterior surface 19 (FIG. 1) of the blade 10, whilst the inner surface 17 of the core 14 and the inner skin 16 face towards an interior region 20 (FIG. 1) of the blade 10.

Referring still to FIG. 2, an impedance layer 21 is provided on the outer skin 15, and a conductive ground plane 22, which functions as a radar reflecting layer, is provided between the core 14 and the inner skin 16. The foam core 14 serves as a dielectric layer between the ground plane 22 and the impedance layer 21.

In this example, the impedance layer 21 is a ‘circuit analogue’ (CA) layer, which comprises a carbon-ink circuit printed on an inner surface 23 of the outer skin 15. The carbon-ink circuit is represented by the array of dashes in FIG. 2. For the avoidance of doubt, the outer skin 15 has been made transparent in FIG. 2 so that the CA layer 21 can be seen; in reality, the CA layer 21 would not be visible through the outer skin 15. The CA layer 21 forms a radar absorbing circuit in combination with the ground plane 22. When radar waves are incident upon the blade 10, the combination of the CA layer 21 and the ground plane 22 act to absorb the radar waves so that they are not reflected back to the radar source. In other examples, an otherwise resistive layer may be used in place of the CA layer 21.

Different regions of a wind turbine blade are subject to different forces. Consequently, sandwich panels at different locations within the blade structure may require different core thicknesses. Typically, the core thickness ranges from 5 mm to 45 mm.

The separation between the impedance layer 21 and the ground plane 22 is a key parameter for radar absorption performance, and must be carefully controlled to achieve a blade 10 having the desired absorption properties. Such careful control of the separation of these layers is made more difficult by the varying geometry of the blade 10, specifically the abovementioned variation in core thickness. Theoretical calculations and experimental trials have shown that sandwich panels having a core thickness between approximately 35 mm to 45 mm cannot be turned into high performance RAM using CA or resistive layers and a ground plane arranged as shown in FIG. 2.

A split core arrangement that provides consistent radar absorption performance in structures where core thickness varies is described in WO2010/122351 and WO2010/122352. The split core divides the thickness of the core between inner and outer core layers disposed about an intermediate ground plane. An example of such a split core, and its incorporation within a wind turbine blade, will now be described briefly by way of background to the present invention, with reference to FIGS. 3a to 3c.

FIG. 3a is a plan view of a wind turbine blade 30 of sandwich panel construction and incorporating a split core; FIG. 3b is an enlarged sectional view of a region close to the root 32 of the blade 30, at which point the sandwich panel has a relatively thick core 34; and FIG. 3c is an enlarged sectional view of a region close to the tip 36 of the blade 30, at which point the sandwich panel has a relatively thin core 38.

Referring to FIGS. 3b and 3c, the split core 34, 38 comprises inner and outer core layers 40 and 42 respectively. A ground plane 44 in the form of a layer of carbon veil is located between the inner and outer core layers 40, 42, and the three layers 40, 42, 44 are bonded together by a suitable adhesive. The split core 34, 38 is disposed inboard of a CA impedance layer 46, which is provided on an outer skin 48 of the blade 30.

The thickness of the outer core layer 42, which defines the separation between the impedance layer 46 and the ground plane 44 is the same in both FIGS. 3b and 3c, whilst the thickness of the inner core layer 40 is different. The inner core layer 40 is thicker in FIG. 3b, i.e. closer to the hub 50, than in FIG. 3c, i.e. closer to the tip 36. Since the thickness of the outer core layer 42 remains uniform across the blade 30, a single design of CA layer 46 may conveniently be utilised across the blade 30 providing that the composition of the outer skin 48 is substantially constant across the blade 30. The thickness of the inner core layer 40 does not affect RAM performance, and so this may be chosen to provide the required overall core thickness of the sandwich panel in accordance with the structural requirements of the blade 30 at the specific location of the sandwich panel within the composite structure.

Sandwich panel cores may include a chamfer along one or more edges to avoid stress concentrations from occurring in a laminate structure. The radar absorption performance of single-core arrangements, such as that shown in FIG. 2, tends to be impaired at core chamfers, whereas split-core arrangements, such as those shown in FIGS. 3b and 3c, perform considerably better for reasons that will now be described with reference to FIGS. 4a and 4b.

FIG. 4a shows a chamfered single-layer core 14 of the type shown in FIG. 2, having a thickness of 30 mm and being disposed between an impedance layer 21 and a ground plane 22. FIG. 4b shows a chamfered split core 34, 38 of the type shown in FIGS. 3b and 3c, having an inner core layer 40 that is 20 mm thick and an outer core layer 42 that is 10 mm thick. A ground plane 44 is embedded within the split core 34, 38, between the inner and outer core layers 40, 42, and the split core 34, 38 is located adjacent an impedance layer 46 such that the outer core layer 42 is between the impedance layer 46 and the ground plane 44.

Generally, a reduction in radar absorption performance occurs when the distance between the impedance layer 21, 46 and the ground plane 22, 44 changes from the distance for which the RAM is optimised. In the case of the single-layer core 14 of FIG. 4a, the separation between the impedance layer 21 and the ground plane 22 changes along the entire length of the core chamfer, i.e. between points a and c on FIG. 3a. However, in the case of the split core of FIG. 4b, the separation between the impedance layer 46 and the ground plane 44 remains constant along the majority of the length of the chamfer, i.e. between points b and c in FIG. 4b. The ground plane 44 terminates at point b, so performance is reduced only at the extreme end of the chamfer, i.e. between points a and b in FIG. 4b, rather than along the entire length of the chamfer, i.e. between points a and c, as is the case for the core 14 in FIG. 4a.

Referring again to FIGS. 3b and 3c, it should be noted that the split core 34, 38 includes several parallel slits: a first plurality of slits 52 is provided in the inner core layer 40 and a second plurality of slits 54 is provided in the outer core layer 42. These slits 52, 54 increase the flexibility of the core 34, 38 and enable the core 34, 38 to drape to conform to the required curvature of the blade shell. To avoid disrupting RAM performance, the slits 52, 54 do not penetrate the ground plane 44. To this end, each slit 52, 54 stops short of the ground plane 44.

Whilst the split cores 34, 38 described above perform well in most cases, in certain situations, for example where high drape is required, these cores have been found to be too rigid. This is due to the rigidity imparted to the core 34, 38 by the embedded ground plane 44 and the adhesive layers that bond the ground plane 44 to the respective core layers 40, 42.

Against this background, it is an object of the present invention to provide a more flexible core capable of consistent RAM performance across a wide range of core thicknesses, including relatively thick cores.

### SUMMARY OF THE INVENTION

According to the present invention there is provided a foam core for a composite structure, the core comprising a first core layer and a second core layer, wherein the first core layer is a dielectric foam material and the second core layer is a radar reflecting ground plane comprising an electrically conductive foam material.

Also in accordance with the present invention there is provided a composite structure of sandwich panel construction and incorporating radar absorbing material (RAM), the composite structure comprising: an impedance layer; and a foam sandwich panel core having a first core layer and a second core layer, the first core layer comprising a dielectric foam material and being located between the second core layer and the impedance layer; wherein the second core layer is a radar reflecting ground plane comprising an electrically conductive foam material.

The foam core is preferably of unitary construction. The first and second core layers are preferably joined together without intermediate layers. Advantageously, the first and second core layers may be joined together without the use of adhesive. For example, in preferred embodiments of the invention, the first and second core layers are both foam layers that are thermally bonded together. The absence of adhesive and the absence of a solid layer such as a carbon layer at the interface between the first and second core layers results in a core that is more flexible than the split cores described by way of background.

The foam material comprising the ground plane may include any suitable electrically conductive material, for example carbon or iron. The electrically conductive material is preferably in the form of particles, for examples particles of carbon or iron. Preferably the electrically conductive material is carbon, and more preferably it is carbon black, which is relatively inexpensive. Foam containing carbon may be referred to herein as ‘carbon-loaded’ foam.

Carbon-loaded foam is known for use as a radar absorbing material. For example, anechoic chambers utilise pyramids of carbon-loaded foam to absorb radar signals. Also, graded absorbers are known, which comprise a series of layers of carbon-loaded foam, with each layer comprising an increasing proportion of carbon. Graded absorbers are backed by a conductive ground plane in the form of a metal sheet. In these prior art examples, the carbon loaded foam acts as the radar absorbing medium, but does not act as the ground plane reflector as is the case for the present invention

The core layers may be formed from open or closed cell structured foam or syntactic foam. Preferably the layers are formed from polyethylene terephthalate (PET) or polyvinyl chloride (PVC) foam. Preferably the first core layer does not include electrically conductive material.

The impedance layer is preferably disposed close to the outer surface of the composite structure. The impedance layer may be provided directly on an outer surface of the first core layer. Alternatively, the impedance layer may be otherwise embedded within the composite structure. For example, the impedance layer may be providing on a layer of glass-fibre fabric prior to incorporating the fabric into the composite structure.

The impedance layer may be a ‘circuit analogue’ (CA) layer, which comprises an array of elements, such as monopoles, dipoles, loops, patches or other geometries provided on a suitable substrate, for example a glass-fibre cloth. The elements are made from a material that has controlled high frequency resistance. The element material and the geometry of the array elements are designed such that the impedance layer exhibits a chosen high frequency impedance spectrum. The impedance spectrum is chosen such that the impedance layer and the ground plane form a radar absorbing circuit in the composite structure. Different impedance spectra are required for different composite structures, for example having different core thicknesses. Alternatively, the impedance layer may be a resistive layer of a type commonly used in RAM.

In a similar way to the split cores described above by way of background, the thickness of the core is divided between the first and second core layers. The thickness of the first core layer is selected in accordance with the specific design of the impedance layer and the required RAM properties. The thickness of the second core layer does not affect RAM performance, and so the thickness of this layer may be selected in accordance with the required structural properties of the sandwich panel. The thickness of the first core layer is preferably substantially uniform across the composite structure, whilst the thickness of the second core layer may vary.

As the thickness of the first core layer may remain the same for all core thicknesses, consistent radar absorption performance can be achieved across an entire composite structure. Furthermore RAM design is less constrained by pre-determined core thicknesses. Functionality is improved because the split core design has consistent RAM performance across all core thicknesses.

The core may comprise additional core layers. For example, the second core layer, which forms the ground plane, may be located between the first core layer and a third core layer. In this way, the total thickness of the core is divided over three core layers. This allows the second core layer to be made relatively thin, which may provide a cost saving because it reduces the amount of core material containing electrically conductive material. In this configuration, the second core layer may be of substantially uniform thickness across the core, whilst the thickness of the third core layer may vary.

The thickness of the third core layer, which may be of relatively inexpensive core material, can be selected to provide the required overall core thickness. The third core material is preferably foam. Preferably all core layers are made from the same type of foam. Preferably the third core layer does not contain electrically conductive material. In the same way as described above, the various core layers may be bonded together without intermediate layers, and/or without adhesive, for example the layers may be thermally bonded. In this way, having additional core layers does not increase the rigidity of the core, so flexibility is maintained. It will be appreciated that further core layers may be provided if required.

The core may be used in prepreg or resin infusion moulding, or in other compatible moulding schemes. For application in a wind turbine blade, the thickness of the first core layer is typically in the range of 10 to 15 mm and the combined thickness of the second and any further core layers is typically in the range of 5 to 35 mm. These thicknesses are suitable for absorbing aviation radar signals in the 1 to 3 gigahertz (GHz) range. However, it will be appreciated that different thicknesses may be required in order to absorb higher or lower frequencies. The split core design enables RAM to be incorporated in relatively thick cores, where using a single-layer core of equivalent thickness would result in poor RAM performance.

For increased flexibility/drapability, a plurality of drape-promoting formations may be provided in the core. The drape-promoting formations are preferably in the form of slits. The slits preferably extend through the entire thickness of the second core layer. Preferably the slits extend at least partially through the thickness of the first core layer. The slits may be provided with or without removal of material from the core layers.

Whilst it was previously thought that penetrating the ground plane would impair its performance as a RAM reflector, it has now been discovered that having a discontinuous ground plane does not necessarily result in impaired performance. For example, through suitable choice of the slit sizes and positions, the ground plane can form a frequency selective surface (FSS) optimised to reflect radar waves of a particular frequency.

The slits may have a V-shaped cross section (otherwise referred to herein as a ‘V/-section’) or a cross-section that otherwise tapers. This may be desirable for preventing excessive resin ingress for a given drapability. For example, the movement capability of a V-section slit is similar to the movement capability of a parallel-sided slit having a slit opening of equivalent size. However, the volume of the V-section slit will be lower than the parallel-sided slit and so resin ingress is lower in the V-shaped slit whilst drapability of the core is similar.

Aside from providing a more flexible core and a FSS, another advantage of the discontinuous second core layer is that it does not interfere with lightning protection systems, which are commonly found in modern wind turbine blades. Prior art conductive ground planes comprise a continuous layer of conductive material, such as carbon. This tends to reduce the electric field around the lightning receptors in wind turbine blades, which can impair the performance of the receptors and may ultimately lead to the blades sustaining damage from a lightning strike. The slits through the second core layer in the present invention interrupt the conductivity of this layer and result in a second layer that comprises a plurality of adjacent, but electrically isolated elements. Experimental tests have shown that an interrupted ground plane does not reduce or otherwise interfere with the electric field around lightning receptors in the same way as a continuous conductive ground plane would. Hence the cores of the present invention may be more compatible with lightning protection systems.

The core may be in the form of discrete panels or sheets. The edges of the panels or sheets may be chamfered to provide chamfered joints between panels. Benefits of the chamfered edges are particularly acute when there is high drape. The split core design of the present invention results in improved RAM performance at core chamfers when compared to prior art single-layer cores, for the reasons described above with reference to FIGS. 4a and 4b.

Parallel slits may be provided in the core layers to facilitate draping in a single direction. Alternatively, the slits may intersect with one another, for example in a criss-cross pattern, to facilitate draping in more than one direction.

In examples of the invention described herein, the composite structure forms part of a wind turbine blade. Accordingly the inventive concept encompasses a wind turbine blade of sandwich panel construction and incorporating radar absorbing material (RAM), the blade comprising: an impedance layer; and a foam sandwich panel core, the core comprising a first core layer and a second core layer, wherein the first core layer is a dielectric foam material and the second core layer is a radar reflecting ground plane comprising an electrically conductive foam material.

It will be appreciated that the optional and/or preferred features described above apply equally when the composite structure is a wind turbine.

The inventive concept also includes a wind turbine having such a blade, and a wind farm comprising one or more such wind turbines.

### BRIEF DESCRIPTION OF THE DRAWINGS

Reference has already been made to FIGS. 1 to 4 of the accompanying drawings in which:

FIG. 1 is a cross section of a wind turbine blade of sandwich panel construction;

FIG. 2 is an exploded sectional perspective view of a sandwich panel having a radar-absorbing construction and incorporated in the wind turbine blade of FIG. 1;

FIG. 3a is a plan view of a wind turbine blade of sandwich panel construction and comprising a split core of the type described in WO2010/122351 and WO2010/122352;

FIG. 3b is an enlarged sectional view of a region close to the root of the blade, at which point the sandwich panel has a relatively thick core;

FIG. 3c is an enlarged sectional view of a region close to the tip of the blade, at which point the sandwich panel has a relatively thin core;

FIG. 4a is a side view of a single core of the type shown in FIG. 2 and having a chamfered edge; and

FIG. 4b is a side view of a split core of the type shown in FIGS. 3b and 3c and having a chamfered edge.

In order that the present invention may be more readily understood, reference will now be made, by way of example, to FIGS. 5 to 10, in which:

FIG. 5 is a schematic cross-sectional side view of a core in accordance with a first embodiment of the present invention;

FIG. 6a is an exploded sectional perspective view of a sandwich panel incorporating the core of FIG. 5 and having an impedance layer provided on an outer core layer;

FIG. 6b is a schematic cross-sectional side view of the sandwich panel of FIG. 6a, showing the reflection and absorption of incident radar signals;

FIG. 7 is an exploded sectional perspective view of a sandwich panel incorporating the core of FIG. 5 and having an impedance layer provided on a surface of the core;

FIG. 8 shows the core of FIG. 5 provided with slits to promote draping;

FIG. 9 shows the core of FIGS. 8 in a draped configuration; and

FIG. 10 shows a core in accordance with a second embodiment of the present invention.

### DETAILED DESCRIPTION

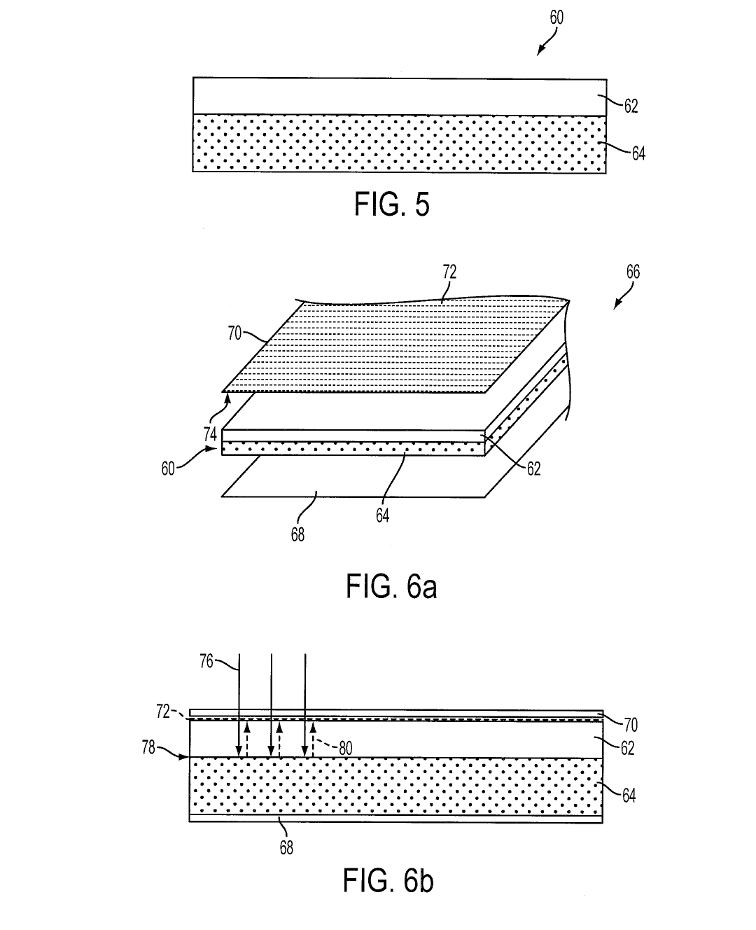

FIG. 5 shows a core 60 in accordance with a first embodiment of the present invention.

The core 60 comprises a first core layer 62 and a second core layer 64, each made of polyethylene terephthalate (PET) or polyvinyl chloride (PVC) foam. The two core layers 62, 64 are thermally bonded together, and hence form a unitary structure without adhesive being required between the layers.

The PET or PVC foam comprising the second core layer 64 is impregnated with particles of carbon black. This ‘carbon-loaded’ foam is electrically conductive, and serves as a radar-reflecting ground plane when the core 60 is incorporated within a composite structure of sandwich panel construction, as will now be described with reference to FIGS. 6a and 6b.

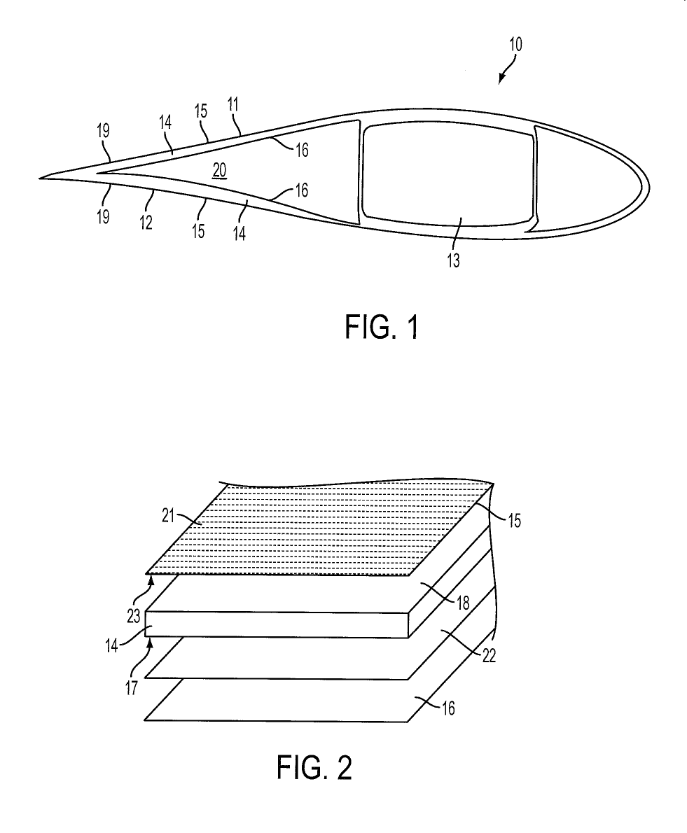

Referring to FIG. 6a, this shows a sandwich panel 66 in exploded form and incorporating the core 60 of FIG. 5. The sandwich panel 66 comprises an inner skin 68 and an outer skin 70, each of glass-fibre composite construction. The core 60 is disposed between the inner and outer skin 68, 70 and oriented such that the first core layer 62 is adjacent the outer skin 70 and the second core layer 64 is adjacent the inner skin 68. The sandwich panel 66 may form part of a composite structure, for example part of a wind turbine blade shell as shown in FIG. 1. When incorporated within a wind turbine blade shell, the outer skin 70 faces an exterior surface of the blade, and the inner skin 68 faces an interior region of the blade.

A circuit analogue (CA) impedance layer 72 comprising a carbon-ink circuit is provided on an inner surface 74 of the outer skin 70. The CA layer 72 is represented by the array of dashes in FIG. 6a. For the avoidance of doubt, the outer skin 70 has been made transparent in FIG. 6a so that the CA layer 72 can be seen; in reality, the CA layer 72 would not be visible through the outer skin 70. The first core layer 62 serves as a dielectric layer between the impedance layer 72 and the ground plane, which is provided by the carbon-loaded foam of the second core layer 64.

Referring now to the side view of FIG. 6b, incoming radar signals 76, represented by solid arrows, are incident upon the outer skin 70, and hence upon the CA layer 72. These radar signals 76 penetrate the CA layer 72 and are reflected at the interface 78 between the first and second core layers 62, 64, as represented by the dashed arrows 80. Reflection at the interface 78 between the first and second core layers 62, 64 is caused by the carbon-loaded foam of the second core layer 64 functioning as the conductive ground plane. The combination of the CA layer 72 and the conductive ground plane act to absorb the radar signals 76 in a manner known in the art, so that these signals are not reflected back to the radar source, or are at least greatly attenuated.

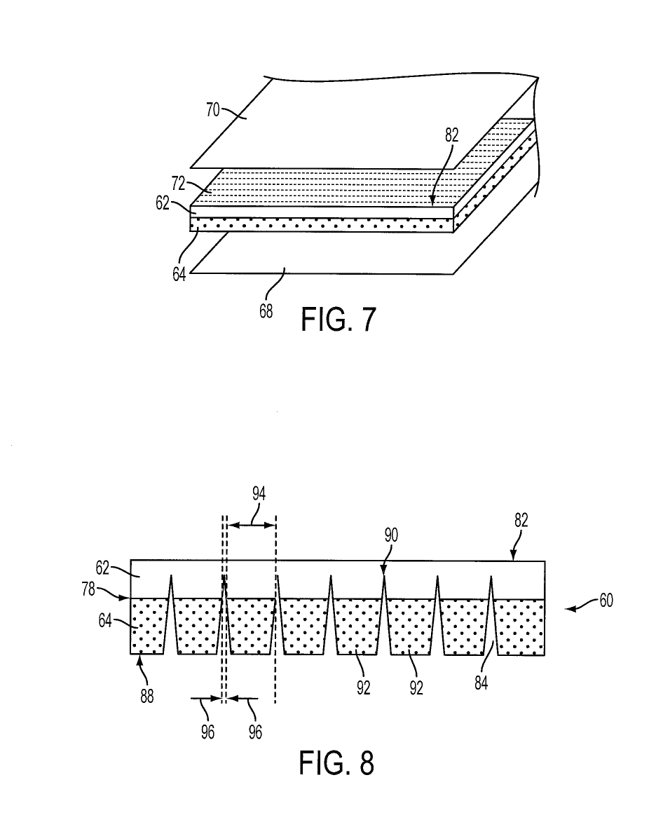

FIG. 7 shows a variant of the sandwich panel 66 of FIG. 6a, in which the CA impedance layer is provided directly on an outer surface 82 of the first core layer 62 instead of being provided on the outer skin 70.

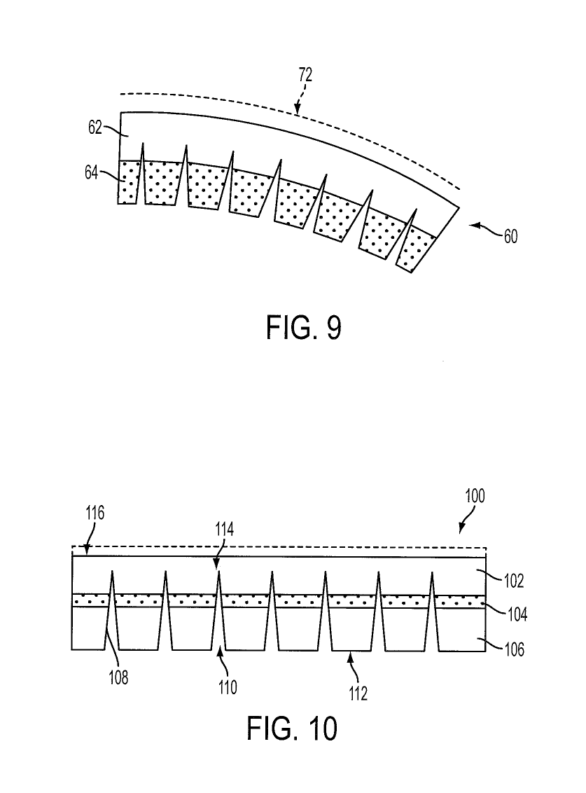

Referring now to FIG. 8, a plurality of parallel slits 84 are provided in the core 60 of FIG. 5 to promote draping so that the core 60 may conform to a curvature of a composite structure such as a wind turbine blade. Each slit 84 is V-shaped in cross section, and tapers inwardly from an open end 86 at an inner surface 88 of the second core layer 64 to a closed end 90 that is within the first core layer 62 and spaced apart from the outer surface 82 of the first core layer 62. Referring to FIG. 9, this shows the core 60 in a draped configuration adjacent the CA layer 72 in a composite structure.

The absence of a carbon layer and the absence of adhesive layers between the first and second core layers 62, 64 mean that the core 60 of the present invention is more flexible than the split cores 34, 38 described above by way of background. Hence the core 60 of the present invention is suitable for incorporation into regions of a composite structure where high levels of draping are required.

Referring again to FIG. 8, once the slits 84 have been cut through the core 60, the second core layer 64 comprises a series of adjacent strips 92 of carbon-loaded foam. In this example, the dimensions of the slits 84 are chosen such that each strip 92 of carbon-loaded foam has a width of approximately 40 mm at the interface 78 between the first and second core layers 62, 64, as represented by arrow 94, and such that the separation between adjacent strips at the interface 78 is approximately 2-3 mm, as indicated by the arrows 96. This configuration of slits 84 results in a frequency selective surface (FSS) that acts as an efficient reflector of radar waves having a frequency of 3 GHz, which is typical of air-traffic control radar.

The slits 84 also ensure that adjacent strips 92 of carbon-loaded foam do not touch, even with typical degrees of drape, and hence are electrically isolated from one another. This disrupts the conductivity of the ground plane and provides improved compatibility with lightning protection systems, such as those incorporated in modern wind turbine blades.

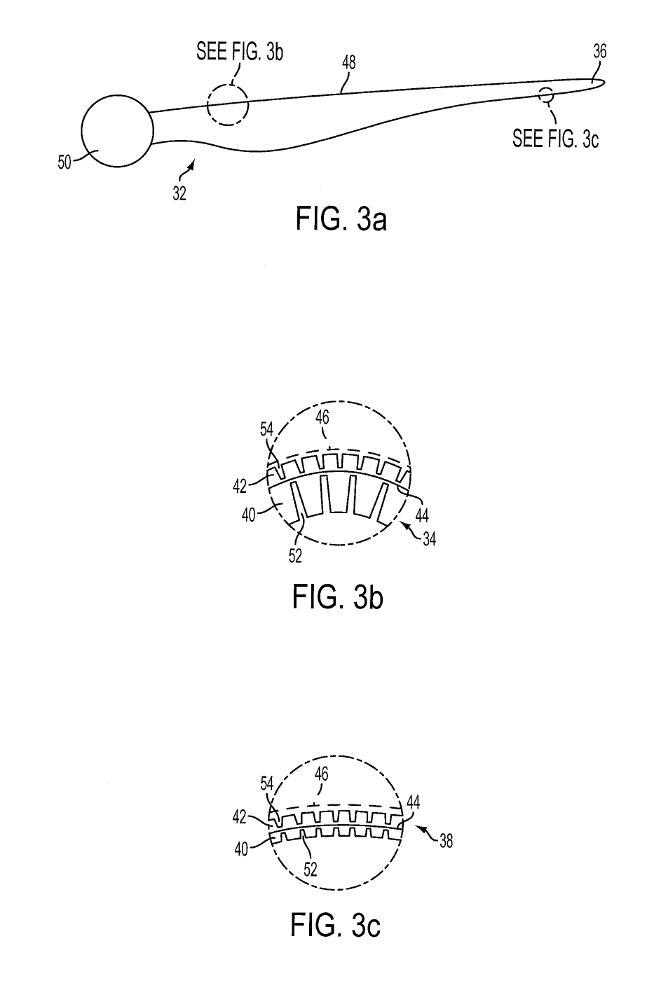

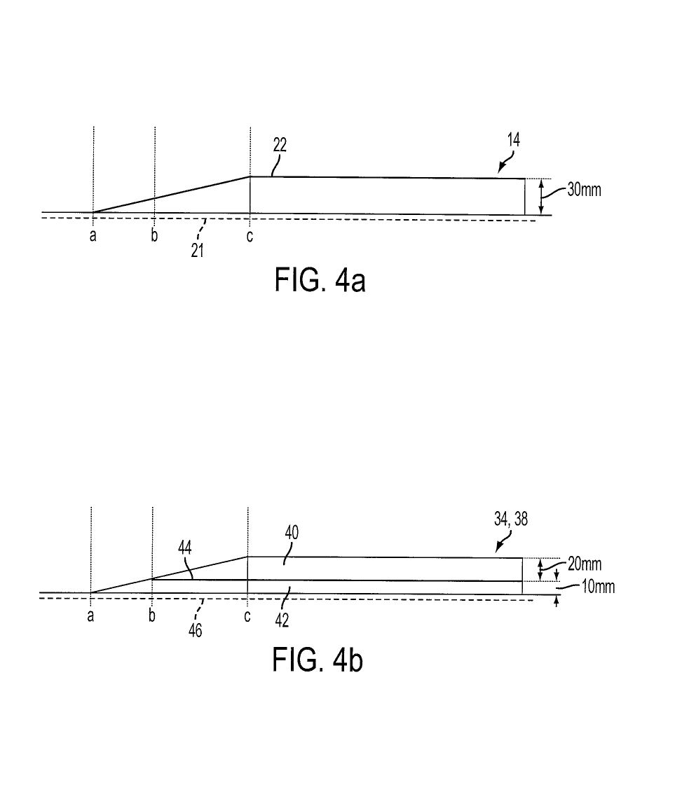

It will be appreciated that the benefits of a split core, which were described by way of background with reference to FIG. 3 apply equally to the cores 60 of the present invention. Hence, a single design of CA layer 72 may be employed irrespective of the total core thickness, because the thickness of the first core layer 62 may be kept uniform across a composite structure such as a wind turbine blade, with the thickness of the second core layer 64 varying in accordance with structural requirements. This ensures that the distance between the impedance layer 72 and the ground plane at the interface 78 between the first and second core layers 62, 64 is kept constant, whilst allowing the total core thickness to vary in accordance with the structural requirements of the blade or other composite structure. In addition, the cores 60 of the present invention have increased performance at core chamfers, for the same reasons as described above in relation to FIGS. 4a and 4b.

As mentioned previously, reflection of incoming radar signals 76 (FIG. 6b) occurs at the interface 78 between the first and second core layers 62, 64. This means that the carbon-loaded foam of the second core layer 64 can be made relatively thin without compromising its performance as a ground plane. Cost savings may be realised by having a relatively thin carbon-loaded foam layer 64 as will now be described with reference to FIG. 10.

Referring to FIG. 10, this shows a core 100 in accordance with a second embodiment of the present invention. The core 100 comprises a first core layer 102, a second core layer 104, and a third core layer 106, each made of PET or PVC foam. The three core layers 102, 104, 106 are thermally bonded together, and hence form a unitary structure without adhesive being required between the layers. Parallel V-section slits 108 are provided in the core 100. The slits 108 extend through the entire thickness of the second and third core layers 104, 106 and each slit 108 tapers inwardly from an open end 110 at an inner surface 112 of the second core layer 106 to a closed end 114 that is within the first core layer 102 and spaced apart from an outer surface 116 of the first core layer 102. The size of the slits 108, and the spacing between adjacent slits 108, may be chosen to provide a FSS in the same way as described above with reference to FIG. 8.

In this embodiment, the second core layer 104 comprises carbon-loaded foam and is located between the first and third core layers 102, 106. The first and third core layers 102, 106 are not carbon-loaded. The carbon-loaded foam provides a conductive ground plane in the same way as described above in relation to the core of FIG. 5. In this arrangement, the thickness of the second core layer 104 may be minimised, whilst the thickness of the third core layer 106 may be chosen in accordance with the required structural properties of the composite structure because the thickness of this layer 106 does not affect RAM performance. As carbon-loaded foam is generally more expensive than standard foam, minimising the thickness of the second core layer 104 may provide a substantial cost saving.

It will be appreciated that additional core layers may be provided inboard of the third core layer 106 if required. Since all core layers 102, 104, 106 may be thermally bonded without adhesive being required, having three or more core layers does not reduce the flexibility of the core 100.

The term ‘slit’ should not be construed in an unduly limiting way. This term may encompass other drape-promoting formations such as discontinuities, grooves, channels, or slots. The term ‘radar’ here is used for convenience and should be interpreted more generally as relating to microwave radiation.

It will be appreciated that variations or modifications may be made to the specific examples described above without departing from the scope of the present invention as defined by the accompanying claims.

1. A foam core for a composite structure, the core comprising a first core layer and a second core layer, wherein the first core layer is a dielectric foam material and the second core layer is a radar reflecting ground plane comprising an electrically conductive foam material.

2. The foam core of claim 1, wherein the foam material comprising the second core layer contains particles of carbon.

3. The foam core of claim 1, wherein the first and second core layers are joined together without intermediate layers.

4. The foam core of claim 1, wherein the first and second core layers are joined together without adhesive.

5. The foam core of claim 1, wherein the first and second core layers are thermally bonded together.

6. The foam core of claim 1, wherein the core further comprises a third core layer and the second core layer is located between the first and third core layers.

7. The foam core of claim 6, wherein the third core layer is made from foam and bonded to the second core layer without adhesive.

8. The foam core of claim 6, wherein the thickness of the third core layer varies across the core.

9. The foam core of claim 8, wherein the thickness of the second core layer is substantially uniform.

10. The foam core of claim 1, wherein the second core layer is discontinuous and comprises a plurality of electrically isolated adjacent elements.

11. The foam core of claim 10, wherein the electrically isolated adjacent elements form a frequency selective surface.

12. The foam core of claim 1, wherein the core further comprises a plurality of drape-promoting formations.

13. The core of claim 12, wherein the drape-promoting formations are in the form of slits that extend through the entire thickness of the second core layer and at least partially through the thickness of the first core layer.

14. The foam core of claim 1, wherein an impedance layer is provided on an outer surface of the first core layer such that the impedance layer and the second core layer are in spaced apart relation and separated by the first core layer, wherein the impedance layer and the second core layer form radar absorbing material.

15. A composite structure of sandwich panel construction and being configured to absorb microwave radiation, wherein the composite structure includes the core of claim 1.

16. The composite structure of claim 15, wherein the composite structure includes an impedance layer and the core is arranged such that the first core layer is between the impedance layer and the second core layer.

17. The composite structure of claim 16, wherein the thickness of the first core layer is substantially uniform across the composite structure.

18. The composite structure of claim 16, wherein the thickness of the second core layer varies across the composite structure to vary the overall thickness of the core.

19. The composite structure of claim 16 in which the core includes a third core layer arranged such the second core layer is between the first and third core layers, wherein the thickness of the third core layer varies across the composite structure.

20. A blade for a wind turbine, the blade comprising the composite structure of claim 15.

21. A wind turbine having a blade according to claim 20, or a wind farm comprising at least one such wind turbine.
